(19) United States
(12) Patent Application Publication
(10) Pub. No.: US 2010/0263508 A1
(43) Pub. Date: Oct. 21, 2010

(54) Cutting apparatus employing high pressure fluid jet

(76) Inventors: Shimaki Hori, Nagoya-shi (JP); Tatsuya Oba, Nagoya-shi (JP); Yoshiaki Urasaki, Nagoya-shi (JP)

Correspondence Address: WENDEROTH, LIND & PONACK, L.L.P., 1030 15th Street, N.W.,, Suite 400 East, Washington, DC, 20005-1503, US

(21) Appl. No.: 12/591,316

(22) Filed: Nov. 16, 2009

Related U.S. Application Data
(63) Continuation of application No. 12/289,505, filed on Oct. 29, 2008, now abandoned.
Application No. 12/289,505 is a continuation of application No. 11/651,457, filed on Jan. 10, 2007, now abandoned.
Application No. 11/651,457 is a continuation of application No. 11/282,687, filed on Nov. 21, 2005, now abandoned.
Application No. 11/282,687 is a division of application No. 10/745,682, filed on Dec. 29, 2003, now abandoned.

(30) Foreign Application Priority Data
Dec. 27, 2002 (JP) 2002-381542

(51) Int. Cl. B26F 3/00

(52) U.S. Cl. 83/53

(57) ABSTRACT

Provided is a cutting apparatus employing a high pressure fluid jet including a super high pressure pump for increasing pressure of a fluid so as to form a super high pressure fluid, a super high pressure fluid nozzle having an orifice for ejecting the super high pressure fluid so as to form a high rate ejected flow, a super high pressure fluid pipeline for connecting the super high pressure pump and the super high pressure fluid nozzle to each other, and a switch valve interposed between the super high pressure fluid nozzle and the super high pressure fluid pipeline so as to connect or disconnect supply of the super high pressure fluid; wherein the super high pressure fluid nozzle is provided in plurality, in which diameters of the orifices provided with nozzles are different from each other, and supply of the super high pressure fluid from the super high pressure fluid pipeline to the super high pressure fluid nozzle is changed from one nozzle to another nozzle of the plural super high pressure fluid nozzles.

This application is a continuation of application Ser. No. 12/289,505, filed Oct. 29, 2008, which is a continuation of application Ser. No. 11/651,457, filed Jan. 10, 2007, which is a continuation of application Ser. No. 11/282,687, filed Nov. 21, 2005, which is a divisional of application Ser. No. 10/745,682, filed Dec. 29, 2003.

### BACKGROUND OF THE INVENTION

1. Field of the Invention

The present invention relates to a cutting method and apparatus employing a high pressure fluid jet, in which a high rate ejection flow is formed by ejecting a super high pressure fluid from a nozzle, thus achieving cutting or the like by allowing this ejection flow to collide with a workpiece.

More particularly, the present invention relates to a cutting method and apparatus employing a high pressure fluid jet suitable for cutting a workpiece made of a plurality of members laminated one on another, with each member having a different quality of material.

2. Description of the Related Art

There has been a conventionally known cutting apparatus employing a high pressure fluid jet. This cutting apparatus includes a super high pressure pump for increasing pressure of a fluid so as to form a super high pressure fluid, a super high pressure fluid nozzle having a very small pore called an orifice for ejecting the super high pressure fluid so as to form a high rate ejection flow, a super high pressure fluid pipeline for connecting the super high pressure pump to the super high pressure fluid nozzle, and a switch valve interposed between the super high pressure fluid nozzle and the super high pressure fluid pipeline, for connecting or disconnecting supply of the super high pressure fluid. Also, there has been a conventionally known cutting method using this apparatus.

In the before described cutting apparatus and cutting method employing a high pressure fluid jet, water or oil is generally used as the fluid.

The above-described apparatus and method is applied to machining, for example, cutting a synthetic resin plate such as a urethane plate or a polypropylene plate, a metallic plate such as an aluminum plate or an iron plate, or plates made of various kinds of materials such as a wood plate and a sponge plate.

A discharge pressure can be generally adjusted in a super high pressure pump in the before described cutting apparatus employing a high pressure fluid jet. It is general that machining energy, for example, cutting energy becomes greater as the discharge pressure in a super high pressure pump in the before described cutting apparatus becomes higher; in contrast, the machining energy, for example, the cutting energy becomes smaller as the discharge pressure in a super high pressure pump in the before described cutting apparatus becomes lower.

In any case, machining may be performed without increasing the discharge pressure in a super high pressure pump in the before described cutting apparatus very much according to a workpiece. For example, a workpiece made of a material which can be cut at a low pressure, is machined. Otherwise, a portion made of a material, which can be cut at a low pressure, is contained in a different material laminated member, in which a plurality of members are laminated, and only a portion made of a material, which can be cut at a low pressure, is intended to be cut.

For example, assume that the discharge pressure in a super high pressure pump in the before described cutting apparatus employing a high pressure fluid jet, having a single super high pressure fluid nozzle securely fixed thereto, required when a urethane plate and a polypropylene plate are to be cut is 196 MPa and 294 MPa, respectively. In this case, the machining energy (i.e., the cutting energy) required for cutting the urethane plate is smaller than that required for cutting the polypropylene plate.

When the polypropylene plate is to be cut, in a case where a laminated member comprising the urethane plate and the polypropylene plate laminated one on another is cut, or when the laminated member in its entirety comprising the urethane plate and the polypropylene plate is cut at one time, a discharge pressure in a super high pressure pump in the before described cutting apparatus is requested to be set to 294 MPa. In contrast, in a case where only the urethane plate is to be cut, a discharge pressure in a super high pressure pump in the before described cutting apparatus is requested to be set to 196 MPa.

As described above, the discharge pressure can be adjusted in the super high pressure pump. And, in general, the cutting energy is greater as the discharge pressure is higher; in contrast, the cutting energy is smaller as the discharge pressure is lower. Thus, the same super high pressure pump, the same super high pressure fluid pipeline and the same super high pressure fluid nozzle can be used in the cutting apparatus employing the high pressure fluid jet by adjusting the discharge pressure in the super high pressure pump according to required machining energy (i.e., required cutting energy), thereby achieving a cutting work using the cutting apparatus employing the high pressure fluid jet without replacing the super high pressure pump, the super high pressure fluid pipeline, and the super high pressure fluid nozzle with others.

However, in a case where required machining energy (i.e., cutting energy) is achieved by adjusting the discharge pressure of the super high pressure pump in the cutting apparatus employing the high pressure fluid jet while using the same super high pressure fluid pipeline, the super high pressure fluid pipeline becomes fatigued, and thus, its lifetime may be markedly shortened since the super high pressure fluid pipeline is expanded or contracted according to fluctuations in pressure.

To solve the above-described problem, if another super high pressure fluid pipeline is used every time the discharge pressure of the super high pressure pump in the cutting apparatus employing the high pressure fluid jet is varied according to the required machining energy (i.e., the cutting energy), there have arisen in turn problems of complication of a system and a high cost.

### SUMMARY OF THE INVENTION

In view of the above-described problems observed in the prior art, an object of the present invention is to provide a cutting method and apparatus employing a high pressure fluid jet, which can provide a suitable machining energy, for example, cutting energy required for machining a workpiece without varying a discharge pressure of a super high pressure pump in the cutting apparatus employing the high pressure fluid jet.

Consequently, another object of the present invention is to prevent a load such as expansion or contraction from being exerted on a super high pressure fluid pipeline even if the cutting apparatus employing the high pressure fluid jet is flexibly used according to a magnitude of machining energy (e.g., cutting energy) required for machining a workpiece.

In order to attain the above-described objects, a cutting apparatus employing the high pressure fluid jet according to the present invention includes a super high pressure pump for increasing pressure of a fluid so as to form a super high pressure fluid, a super high pressure fluid nozzle having an orifice, for ejecting the super high pressure fluid so as to form a high rate ejection flow, a super high pressure fluid pipeline for connecting the super high pressure pump and the super high pressure fluid nozzle to each other, and a switch valve interposed between the super high pressure fluid nozzle and the super high pressure fluid pipeline so as to connect or disconnect supply of the super high pressure fluid.

A cutting apparatus employing the high pressure fluid jet according to the present invention further includes a plurality of super high pressure fluid nozzles, in which a diameter of the orifice provided with each nozzle is different from a diameter of the orifice each other nozzle, and supply of the super high pressure fluid to the super high pressure fluid nozzles can be changed from any one of the nozzles to any other nozzle.

A cutting method employing a high pressure fluid jet proposed by the present invention is conducted by the before described cutting apparatus employing the high pressure fluid jet according to the present invention. That is to say, a cutting method employing a high pressure fluid jet proposed by the present invention is conducted by the cutting apparatus employing the high pressure fluid jet including a super high pressure pump for increasing pressure of a fluid so as to form a super high pressure fluid, a super high pressure fluid nozzle having an orifice for ejecting the super high pressure fluid so as to form a high rate ejection flow, a super high pressure fluid pipeline for connecting the super high pressure pump and the super high pressure fluid nozzle to each other, and a switch valve interposed between the super high pressure fluid nozzle and the super high pressure fluid pipeline so as to connect or disconnect supply of the super high pressure fluid, wherein the cutting apparatus employing the high pressure fluid jet includes a plurality of super high pressure fluid nozzles, in which a diameter of an orifice provided with each nozzle is different from a diameter of the orifice of each other nozzle, and supply of the super high pressure fluid from the super high pressure fluid pipeline to the super high pressure fluid nozzles is changed from one nozzle to another nozzle in the plural number of super high pressure fluid nozzles.

In the cutting method employing a high pressure fluid jet proposed by the present invention conducted by using the before described cutting apparatus employing the high pressure fluid jet according to the present invention, cutting energy is varied by changing the super high pressure fluid nozzle having one orifice, to which the high pressure fluid jet is supplied from the super high pressure fluid pipeline, to another super high pressure fluid nozzle having another orifice, with a diameter of another orifice being different from the one orifice, while keeping a discharge pressure of the super high pressure pump in the cutting apparatus employing the high pressure fluid jet constant. Thereby, the cutting method employing a high pressure fluid jet is achieved.

Between machining energy (i.e., cutting energy) in the cutting apparatus and cutting method employing the high pressure fluid jet and discharge pressure of the super high pressure pump in the cutting apparatus employing the high pressure fluid jet, there is established the following relationship.

(the discharge pressure of the super high pressure pump)×(the flow rate of a fluid ejected from the orifice formed at the super high pressure fluid nozzle)=the machining energy (i.e., the cutting energy)

Therefore, even in a case where the discharge pressure of the super high pressure pump in the cutting apparatus employing the high pressure fluid jet is kept constant so as to prevent a load such as expansion or contraction from being exerted on the super high pressure fluid pipeline, the machining energy (i.e., the cutting energy) can be adjusted by adjusting the flow rate of the super high pressure fluid ejected from the orifice formed in the super high pressure fluid nozzle.

Thus, the present invention is directed to that cutting energy can be varied by changing the super high pressure fluid nozzle to another super high pressure fluid nozzle, in which the orifices formed in the super high pressure fluid nozzles, respectively, have different diameters relative to each other, while keeping the discharge pressure of the super high pressure pump constant.

In the above-described method and apparatus according to the present invention, the cutting energy is adjusted flexibly according to a magnitude of the cutting energy required for cutting a workpiece to be cut, thereby achieving cutting work, while a load such as expansion or contraction can be prevented from being exerted on the super high pressure fluid pipeline while keeping the discharge pressure of the super high pressure pump constant and using the same super high pressure pump and the same super high pressure fluid pipeline.

In other words, in the method and apparatus according to the present invention, even in a case where a different material laminate member, in which a plurality of materials requiring different magnitudes of cutting energy are laminated one on another, is cut, a desired cutting work can be performed while keeping a discharge pressure of the super high pressure pump constant and using the same super high pressure pump and the same super high pressure fluid pipeline.

For example, as described above, it is assumed that a urethane plate requiring a cutting energy corresponding to 196 MPa of the discharge pressure of the super high pressure pump is laminated on a polypropylene plate requiring a cutting energy corresponding to 294 MPa of the discharge pressure of the super high pressure pump. In the method and apparatus according to the present invention, in the case where the different material laminate member is to be cut, such that the before described laminate member comprising the urethane plate on the polypropylene plate is to be cut, while keeping the discharge pressure of the super high pressure pump constant while using the same super high pressure pump and the same super high pressure fluid pipeline, for example, a nozzle provided with an orifice having a diameter of 8/1000 inch is used when the entire member is cut at one time; in the meantime, a nozzle provided with an orifice having a diameter of 3/1000 inch is used when only the urethane plate is cut. Thus, it is possible to achieve the cutting energy required for cutting work in both cases by changing the super high pressure fluid nozzle provided with an orifice having a diameter of 8/1000 inch to the other super high pressure fluid nozzle provided with an orifice having a diameter of 3/1000 inch.

To sum up, according to the present invention, a nozzle provided with an orifice having a desired diameter is used according to material of a workpiece to be cut while keeping discharge pressure of the super high pressure pump constant and using the same super high pressure pump and the same super high pressure fluid pipeline, thus achieving cutting energy required for performing cutting work.

According to the present invention, since the proper cutting energy can be selected by replacing the nozzle with the other nozzle provided with the orifice having the desired diameter, the cutting apparatus and method becomes economical, and further, different kinds of plates can be readily cut by the single high pressure pump.

In this manner, since the discharge pressure of the super high pressure pump is kept constant even if different workpieces to be cut, requiring different cutting energy for cutting work, are cut, a load such as expansion or contraction cannot be exerted on the super high pressure fluid pipeline. As a consequence, it is possible to prevent any danger of occurrence of fatigue or degradation of the super high pressure fluid pipeline, so as to remarkably prolong a useful life thereof.

In the above-described cutting apparatus employing the high pressure fluid jet according to the present invention, a switch valve for connecting or disconnecting supply of the super high pressure fluid is provided in each of the nozzles, and thus, the super high pressure fluid pipeline of one system connects from the super high pressure pump to each of the switch valves.

Here, this connection via the super high pressure fluid pipeline of one system signifies that since the discharge pressure of the super high pressure pump is kept constant in the cutting apparatus employing the high pressure fluid jet according to the present invention, the super high pressure pump is connected to each of the switch valves via one kind of super high pressure fluid pipeline suitable for the constantly kept discharge pressure. As described above, if the super high pressure fluid pipeline is one kind suitable for a constantly maintained discharge pressure, a mode in which the super high pressure pump is connected to each of the switch valves via independent super high pressure fluid pipelines, and a mode in which a super high pressure fluid pipeline extending from the super high pressure pump is branched toward each of a plurality of switch valves in the vicinity of the switch valves, may be included in a concept of the super high pressure fluid pipeline of one system.

Furthermore, in the above-described cutting apparatus employing the high pressure fluid jet according to the present invention, the super high pressure fluid nozzles may be disposed in a robot hand of a revolute robot. In this manner, a nozzle capable of achieving desired cutting energy out of a plurality of nozzles can be exposed to a portion of a workpiece to be cut, thereby achieving cutting work.

Incidentally, in the above-described method and apparatus according to the present invention, water or oil can be used as the fluid.

### BRIEF DESCRIPTION OF THE DRAWINGS

FIG. 1 is a side view showing a cutting apparatus in an embodiment according to the present invention, although a part is omitted;

FIG. 2 is a front view showing the cutting apparatus in the embodiment according to the present invention, although a part is omitted;

FIG. 3(a) is a side view illustrating a case where only an upper layer of a laminate member is cut; and

FIG. 3(b) is a side view illustrating a case where both of upper and lower layers of the laminate member are cut.

### DETAILED DESCRIPTION OF THE PREFERRED EMBODIMENTS

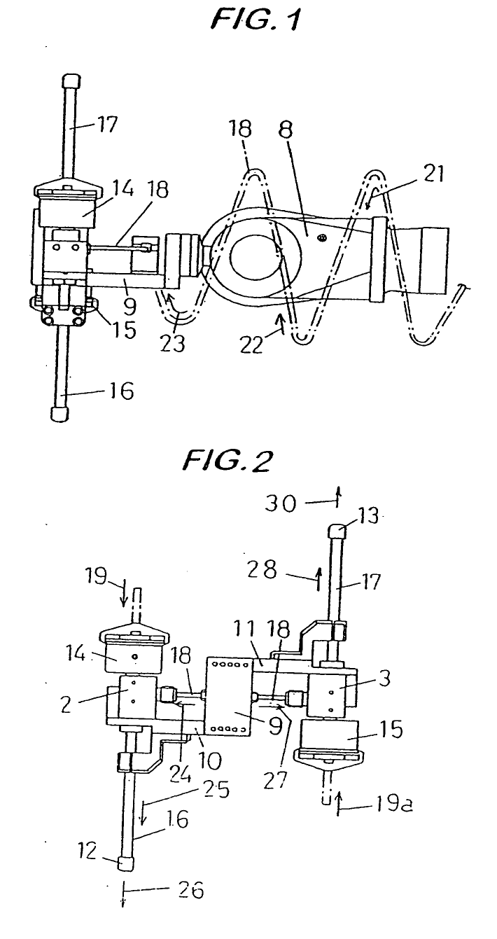

A preferred embodiment according to the present invention will be described below in reference to FIGS. 1 to 3(b).

As shown in FIG. 1, one end of a valve frame 9 is fixed at a tip of a robot hand 8 of a revolute robot, not shown. To another end of the valve frame 9 are fixed switch valves 2 and 3 via fixing arms 10 and 11, respectively, as shown in FIG. 2. The switch valves 2 and 3 are connected at one end thereof to actuators 14 and 15, while at another end thereof to one end of nozzle tubes 16 and 17, respectively. A pore diameter of each of the nozzle tubes 16 and 17 on a side connected to the switch valves 2 and 3 is formed of a normal size.

In contrast, a nozzle 12 provided with an orifice having a diameter of 3/1000 inch, and a nozzle 13 provided with an orifice having a diameter of 8/1000 inch, are fixed at another end of the nozzle tubes 16 and 17, respectively.

To the switch valves 2 and 3 are connected a super high pressure fluid pipeline 18 connected at a base end thereof to a discharge side of a super high pressure pump, not shown. Thus, high pressure water comes up to the switch valves 2 and 3 at all times. Here, a discharge pressure of the super high pressure pump, not shown, is kept constant.

First, a tip of the nozzle 12 is exposed to a portion of a workpiece to be cut by moving the robot hand 8 of the revolute robot, not shown.

Subsequently, when pressurized air is supplied to the actuator 14 as indicated by arrow 19, the switch valve 2 is opened. Then, high pressure water flows through the super high pressure fluid pipeline 18 as indicated by arrows 21, 22, 23 and 24, and thereafter, is ejected from the orifice of nozzle 12, as indicated by an arrow 26, through the nozzle tube 16, as indicated by an arrow 25.

In this manner, upon completion of a desired cutting work, supply of the pressurized air to the actuator 14 is stopped. Thus, the switch valve 2 is closed, so that ejection of the high pressure water is stopped.

Next, a tip of the nozzle 13 is exposed to the portion of the workpiece to be cut by moving the robot hand 8 of the revolute robot, not shown.

Subsequently, when pressurized air is supplied to the actuator 15 as indicated by arrow 19a, the switch valve 3 is opened. Then, high pressure water flows through the super high pressure fluid pipeline 18 as indicated by arrows 21, 22, 23 and 27, and thereafter, is ejected from the orifice of nozzle 13, as indicated by arrow 30, through nozzle tube 17, as indicated by arrow 28.

In this manner, upon completion of a desired cutting work, supply of the pressurized air to the actuator 15 is stopped. Thus, the switch valve 3 is closed, so that ejection of the high pressure water is stopped.

In the present embodiment, workpiece 20 to be cut is a different material laminate member, in which a urethane plate 27 as an upper layer is laminated onto a polypropylene plate 29 as a lower layer. Here, a discharge pressure of the super high pressure pump corresponding to a cutting energy required for cutting the urethane plate, while the same super high pressure fluid pipeline and single super high pressure fluid nozzle securely fixed thereto are used, is set to 196 MPa; in contrast, a discharge pressure of the super high pressure pump corresponding to a cutting energy required for cutting the polypropylene plate is set to 294 MPa.

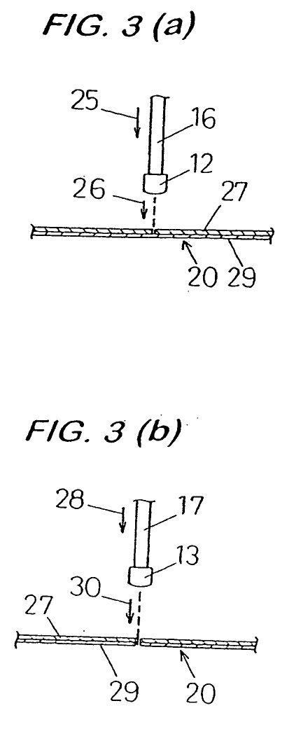

In this case, in the above-described embodiment according to the present invention, high pressure water is ejected from the nozzle 12 provided with the orifice having a diameter of 3/1000 inch while a discharge pressure of the super high pressure pump, not shown, is kept constant, so that only the urethane plate 27, which can be cut with a small cutting energy, is cut, as shown in FIG. 3(a).

Moreover, the high pressure water is ejected from the nozzle 13 provided with the orifice having a diameter of 8/1000 inch while a discharge pressure of the super high pressure pump, not shown, is kept constant, so that the polypropylene plate 29, requiring a large cutting energy for cutting, is cut, as shown in FIG. 3(b).

Alternatively, only the urethane plate 27 may be first cut by ejection of the high pressure water from the nozzle 12, and then, the polypropylene plate 29 may be cut by ejection of the high pressure water from the nozzle 13. Otherwise, the high pressure water may be first injected from the nozzle 13, so that the urethane plate 27 and the polypropylene plate 29 may be cut at the same time.

Although the present invention has been described with reference to a preferred embodiment thereof, it should be understood that the present invention is not limited to this embodiment, and various changes or modifications may be made to the embodiment without departing from the spirit and scope of the invention as defined in the appended claims.

What is claimed is:

1. A method comprising:
using a cutting apparatus including
(i) a super high pressure pump,
(ii) a first super high pressure fluid nozzle having a first orifice, and a second super high pressure fluid nozzle having a second orifice, with said first orifice having a diameter different than a diameter of said second orifice,
(iii) a super high pressure fluid pipeline interconnecting said super high pressure pump and said first and second super high pressure fluid nozzles, and
(iv) a valve unit interposed between said first super high pressure fluid nozzle and said second super high pressure fluid nozzle, to cut a member having a first material laminated onto a second material, with said first material requiring a first magnitude of cutting energy to be cut and said second material requiring a second magnitude of cutting energy to be cut, and with said first magnitude of cutting energy being different than said second magnitude of cutting energy,
wherein using said cutting apparatus to cut said member comprises
(i) using said super high pressure pump to increase pressure of a fluid so as to form a super high pressure fluid,
(ii) supplying said super high pressure fluid from said super high pressure pump while said valve unit is activated in a first manner such that said super high pressure fluid flows through said super high pressure fluid pipeline, is ejected from said first orifice under a first discharge pressure so as to provide said first magnitude of cutting energy, and cuts said first material, and then
(iii) supplying said super high pressure fluid from said super high pressure pump while said valve unit is activated in a second manner such that said super high pressure fluid flows through said super high pressure fluid pipeline, is ejected from said second orifice under a second discharge pressure so as to provide said second magnitude of cutting energy, and cuts said second material.

2. The method according to claim 1, wherein
supplying said super high pressure fluid from said super high pressure pump such that said first material is cut comprises supplying said super high pressure fluid from said super high pressure pump such that said first material is cut completely therethrough without cutting completely through said second material.

3. The method according to claim 2, wherein
supplying said super high pressure fluid from said super high pressure pump such that said second material is cut comprises supplying said super high pressure fluid from said super high pressure pump such that said second material is cut completely therethrough.

4. The method according to claim 3, wherein
supplying said super high pressure fluid from said super high pressure pump while said valve unit is activated in a first manner and supplying said super high pressure fluid from said super high pressure pump while said valve unit is activated in said second manner comprise supplying said super high pressure fluid from said super high pressure pump while a discharge pressure of said super high pressure pump remains constant such that said first discharge pressure is different than said second discharge pressure.

5. The method according to claim 4, wherein
supplying said super high pressure fluid from said super high pressure pump such that said first discharge pressure is different than said second discharge pressure comprises supplying said super high pressure fluid from said super high pressure pump such that said first discharge pressure is less than said second discharge pressure, whereby said first magnitude of cutting energy is less than said second magnitude of cutting energy.

6. The method according to claim 5, wherein
said first material comprises urethane and said second material comprises polypropylene.

7. The method according to claim 2, wherein
supplying said super high pressure fluid from said super high pressure pump while said valve unit is activated in a first manner and supplying said super high pressure fluid from said super high pressure pump while said valve unit is activated in said second manner comprise supplying said super high pressure fluid from said super high pressure pump while a discharge pressure of said super high pressure pump remains constant such that said first discharge pressure is different than said second discharge pressure.

8. The method according to claim 7, wherein
supplying said super high pressure fluid from said super high pressure pump such that said first discharge pressure is different than said second discharge pressure comprises supplying said super high pressure fluid from said super high pressure pump such that said first discharge pressure is less than said second discharge pressure, whereby said first magnitude of cutting energy is less than said second magnitude of cutting energy.

9. The method according to claim 1, wherein
supplying said super high pressure fluid from said super high pressure pump while said valve unit is activated in a first manner and supplying said super high pressure fluid from said super high pressure pump while said valve unit is activated in said second manner comprise supplying said super high pressure fluid from said super high pressure pump while a discharge pressure of said super high pressure pump remains constant such that said first discharge pressure is different than said second discharge pressure.

10. The method according to claim 9, wherein
supplying said super high pressure fluid from said super high pressure pump such that said first discharge pressure is different than said second discharge pressure comprises supplying said super high pressure fluid from said super high pressure pump such that said first discharge pressure is less than said second discharge pressure, whereby said first magnitude of cutting energy is less than said second magnitude of cutting energy.

11. The method according to claim 1, wherein said valve unit comprises a first switch valve between said first super high pressure fluid nozzle and said super high pressure fluid pipeline, and a second switch valve between said second super high pressure fluid nozzle and said super high pressure fluid pipeline,
such that supplying said super high pressure fluid from said super high pressure pump while said valve unit is activated in said first manner comprises supplying said super high pressure fluid from said super high pressure pump while said first check valve and said second check valve are in first positions allowing said super high pressure fluid to flow through said super high pressure fluid pipeline and be ejected from said first super high pressure fluid nozzle but not from said second super high pressure fluid nozzle, and
such that supplying said super high pressure fluid from said super high pressure pump while said valve unit is activated in said second manner comprises supplying said super high pressure fluid from said super high pressure pump while said first check valve and said second check valve are in second positions allowing said super high pressure fluid to flow through said super high pressure fluid pipeline and be ejected from said second super high pressure fluid nozzle but not from said first super high pressure fluid nozzle.

12. The method according to claim 11, wherein
supplying said super high pressure fluid from said super high pressure pump such that said first material is cut comprises supplying said super high pressure fluid from said super high pressure pump such that said first material is cut completely therethrough without cutting completely through said second material.

13. The method according to claim 12, wherein
supplying said super high pressure fluid from said super high pressure pump such that said second material is cut comprises supplying said super high pressure fluid from said super high pressure pump such that said second material is cut completely therethrough.

14. The method according to claim 13, wherein
supplying said super high pressure fluid from said super high pressure pump while said first and second check valves are in said first positions and supplying said super high pressure fluid from said super high pressure pump while said first and second check valves are in said second positions comprise supplying said super high pressure fluid from said super high pressure pump while a discharge pressure of said super high pressure pump remains constant such that said first discharge pressure is different than said second discharge pressure.

15. The method according to claim 14, wherein
supplying said super high pressure fluid from said super high pressure pump such that said first discharge pressure is different than said second discharge pressure comprises supplying said super high pressure fluid from said super high pressure pump such that said first discharge pressure is less than said second discharge pressure, whereby said first magnitude of cutting energy is less than said second magnitude of cutting energy.

16. The method according to claim 15, wherein
said first material comprises urethane and said second material comprises polypropylene.

17. The method according to claim 12, wherein
supplying said super high pressure fluid from said super high pressure pump while said first and second check valves are in said first positions and supplying said super high pressure fluid from said super high pressure pump while said first and second check valves are in said second positions comprise supplying said super high pressure fluid from said super high pressure pump while a discharge pressure of said super high pressure pump remains constant such that said first discharge pressure is different than said second discharge pressure.

18. The method according to claim 17, wherein
supplying said super high pressure fluid from said super high pressure pump such that said first discharge pressure is different than said second discharge pressure comprises supplying said super high pressure fluid from said super high pressure pump such that said first discharge pressure is less than said second discharge pressure, whereby said first magnitude of cutting energy is less than said second magnitude of cutting energy.

19. The method according to claim 11, wherein
supplying said super high pressure fluid from said super high pressure pump while said first and second check valves are in said first positions and supplying said super high pressure fluid from said super high pressure pump while said first and second check valves are in said second positions comprise supplying said super high pressure fluid from said super high pressure pump while a discharge pressure of said super high pressure pump remains constant such that said first discharge pressure is different than said second discharge pressure.

20. The method according to claim 19, wherein
supplying said super high pressure fluid from said super high pressure pump such that said first discharge pressure is different than said second discharge pressure comprises supplying said super high pressure fluid from said super high pressure pump such that said first discharge pressure is less than said second discharge pressure, whereby said first magnitude of cutting energy is less than said second magnitude of cutting energy.
